(19) United States
(12) Patent Application Publication
(10) Pub. No.: US 2016/0228961 A1
(43) Pub. Date: Aug. 11, 2016

(54) INTERNAL-GEAR MACHINING DEVICE AND INTERNAL-GEAR MACHINING METHOD

(71) Applicant: MITSUBISHI HEAVY INDUSTRIES MACHINE TOOL CO., LTD., Ritto-shi, Shiga (JP)

(72) Inventors: Yoshikoto YANASE, Tokyo (JP); Koichi MASUO, Tokyo (JP); Masashi OCHI, Tokyo (JP)

(73) Assignee: MITSUBISHI HEAVY INDUSTRIES MACHINE TOOL CO., LTD., Ritto-shi, Shiga (JP)

(21) Appl. No.: 15/022,789

(22) PCT Filed: Jun. 9, 2014
(86) PCT No.: PCT/JP2014/065175

§ 371 Date: Mar. 17, 2016

(30) Foreign Application Priority Data
Sep. 19, 2013 (JP) 2013-193804

(51) Int. Cl. B23F 5/16

(52) U.S. Cl. CPC B23F 5/163

(57) ABSTRACT

Provided is an internal-gear machining device and an internal-gear machining method capable of offsetting an angle of inclination at a cutter axis using a conventional configuration and performing high-precision machining. The internal-gear machining device gear cuts a workpiece with a pinion cutter by feeding and causing the pinion cutter to cut while synchronously rotating the pinion cutter and the workpiece in mesh with each other, wherein prior to gear cutting, the pinion cutter is positioned so that a cutter axis is parallel shifted within a XY plane in accordance with the angle of inclination of the cutter axis, and a meshing position of the pinion cutter and the workpiece is shifted in a cutter rotational direction.

### TECHNICAL FIELD

The present invention relates to an internal-gear machining device and an internal-gear machining method capable of offsetting an inclination of a pinion cutter.

### BACKGROUND ART

Gear machining devices that perform generating gear-cutting on a workpiece with a pinion cutter have been described in the conventional art. Such a gear machining device is used when performing machining that is difficult with a hob, which along with a pinion cutter is also a gear cutting tool, such as cutting an internal gear on a workpiece. An example of such a gear machining device is described in Patent Document 1.

### CITATION LIST

### Patent Literature

Patent Literature 1: Japanese Unexamined Patent Application Publication No. 2012-218100A

### SUMMARY OF INVENTION

### Technical Problem

Such conventional gear machining devices are configured such that the pinion cutter rotates about the cutter axis when cutting the workpiece. However, due to errors in the assembly of the device and the like, the cutter axis may be inclined in an undesired direction. When cutting is performed with the cutter axis, which corresponds to the axis of the pinion cutter, inclined in an undesired direction, the quality of the gear becomes worse.

To solve the problem described above, the mechanism capable of adjusting the angle of inclination of the cutter axis can be provided in the gear machining device, however complicating the configuration of the device is not advantageous.

To solve the problem described above, an object of the present invention is to provide an internal-gear machining device and an internal-gear machining method capable of offsetting an angle of inclination at the cutter axis using a conventional device and perform high-precision machining.

### Solution to Problem

To resolve the problem described above, an internal-gear machining device according to a first invention
cuts an internal gear to be machined rotatable about a workpiece axis with a gear-shaped cutter rotatable about a cutter axis by feeding and causing the gear-shaped cutter to cut while synchronously rotating the internal gear to be machined and the gear-shaped cutter in mesh with each other.

The internal-gear machining device comprises a cutting unit that infeeds the gear-shaped cutter in an infeeding direction orthogonal to the workpiece axis;
a cutter transverse feeding unit that moves the gear-shaped cutter in a transverse direction orthogonal to the infeeding direction and the cutter axis;
a cutter feeding unit that moves the gear-shaped cutter in a feeding direction parallel to the workpiece axis;
a swivel unit that swivels the cutter axis about a cutter swivel axis extending in the infeeding direction and sets a crossed axis angle between the cutter axis and the workpiece axis; and
a detecting unit that detects an angle of inclination with respect to a first plane of the cutter axis having the crossed axis angle, the first plane including the transverse axis and the feeding axis.

In such an internal-gear machining device, prior to gear cutting, the gear-shaped cutter is positioned so that the cutter axis is parallel shifted by the cutting unit and the cutter transverse feeding unit within a second plane in accordance with the angle of inclination detected by the detecting unit, the second plane including the cutting axis and the transverse axis, and a meshing position of the gear-shaped cutter and the internal gear to be machined is shifted in a rotational direction of the gear-shaped cutter.

To resolve the problem described above, an internal-gear machining device according to a second invention has a configuration in which the gear-shaped cutter is cylindrical; and
a relief angle is set at the meshing position of the gear-shaped cutter having the parallel shifted cutter axis.

To resolve the problem described above, an internal-gear machining method according to a third invention comprises the step of
cutting an internal gear to be machined rotatable about a workpiece axis with a gear-shaped cutter rotatable about a cutter axis by feeding the gear-shaped cutter in a feeding direction parallel to the workpiece axis and causing the gear-shaped cutter to cut in an infeeding direction orthogonal to the workpiece axis while synchronously rotating the internal gear to be machined and the gear-shaped cutter in mesh with each other; and comprises the steps performed prior to the gear cutting of:
setting a crossed axis angle between the cutter axis and the workpiece axis by swiveling the cutter axis;
detecting an angle of inclination with respect to a first plane of the cutter axis having the crossed axis angle, the first plane including a transverse axis orthogonal to the infeeding direction and the cutter axis and the feeding axis; and
shifting a meshing position of the gear-shaped cutter and the internal gear to be machined in a rotational direction of the gear-shaped cutter by positioning the gear-shaped cutter so that the cutter axis is parallel shifted within a second plane in accordance with the angle of inclination, the second plane including the cutting axis and the transverse axis.

### Advantageous Effects of Invention

In such a manner, according to the internal-gear machining device and internal-gear machining method of the present invention, prior to gear cutting, the gear-shaped cutter is positioned so that the cutter axis is parallel shifted within the second plane in accordance with the angle of inclination of the cutter axis, and the meshing position of the gear-shaped cutter and the internal gear to be machined is shifted in the cutter rotational direction. As a result, even should the angle of inclination be set at the cutter axis due to errors in the assembly of the device and the like, the angle of inclination can be offset using a conventional configuration, and high-precision machining can be performed.

### BRIEF DESCRIPTION OF DRAWINGS

FIG. 1 is an overall perspective view illustrating an internal-gear machining device according to an embodiment of the present invention.

FIG. 2 is a perspective view illustrating an internal-gear machining method according to an embodiment of the present invention.

FIG. 3 is a view illustrating how a cutter axis of a pinion cutter is inclined with respect to a YZ plane.

FIG. 4A is a plan view illustrating how a workpiece is gear cut with the pinion cutter having a cutter axis positioned at a reference position.

FIG. 4B is a cross-sectional view taken along line I-I in FIG. 4A in the direction of the arrows.

FIG. 5A is a plan view illustrating how a workpiece is gear cut with the pinion cutter having a cutter axis positioned at an offset position.

FIG. 5B is a cross-sectional view taken along line II-II in FIG. 5A in the direction of the arrows.

FIG. 6 is a cross-sectional view taken along line in FIG. 5B in the direction of the arrows illustrating how a relief angle is set at the pinion cutter.

### DESCRIPTION OF EMBODIMENTS

Below, an internal-gear machining device and an internal-gear machining method according to the present invention are described in detail using the drawings.

### Embodiments

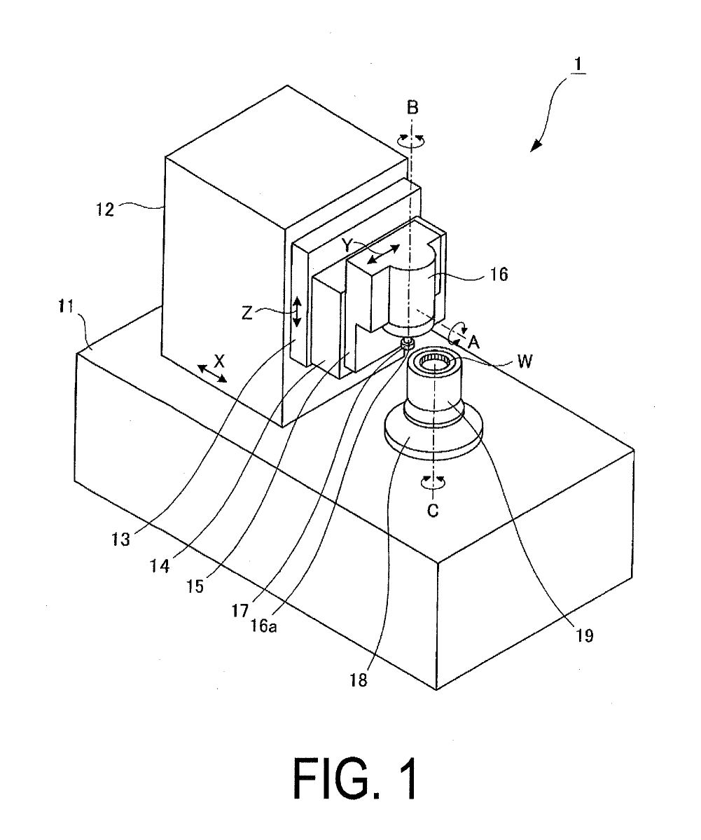

As illustrated in FIG. 1, a column (cutting unit) 12 is supported on a bed 11 of an internal-gear machining device (for example, a gear grinder) 1 in such a manner so as to be able to be infeed in the horizontal X axis direction (infeeding direction). In addition, a saddle (cutter feeding unit) 13 is supported on the front face of the column 12 in such a manner so as to be vertically moveable in the Z axis direction (feeding direction) orthogonal to the X axis direction. Furthermore, a swivel head (swivel unit, crossed axis angle setting unit) 14 is supported on the front face of the saddle 13 in such a manner so as to be able to swivel about the cutter swivel axis A that extends in the X axis direction.

In addition, a slide head (cutter transverse feeding unit) 15 is supported on the front face of the swivel head 14 in such a manner so as to be moveable in the Y axis direction (transverse axis direction) corresponding to the transverse direction of the internal-gear machining device 1 (below, referred to as the “device transverse direction”). Furthermore, a cutter head 16 is set on the front portion of the slide head 15 in a semi-circular shape from the slide head 15. Moreover, a main shaft 16a is supported in the cutter head 16 in such a manner so as to be rotatable about the cutter axis B orthogonal to the X and Y axis directions. A cylindrical pinion cutter (gear shaped cutter) 17 is detachably mounted on the top of the main shaft 16a.

Next, a rotary table (workpiece rotating unit) 18 is supported to the front of the column 12 on the bed 11 in such a manner so as to be rotatable about a workpiece axis C that extends in the Z axis direction. In addition, a cylindrical fixing jig 19 is fixed to the upper face of the rotary table 18. A workpiece (internal gear to be machined) W is detachably mounted inside the top portion of the fixing jig 19. Note that the center of the workpiece W and the workpiece axis C of the rotary table 18 are coaxial when the workpiece W is mounted in the fixing jig 19.

Consequently, the pinion cutter 17 can be caused to cut in the X axis direction and be fed in the Z axis direction by the column 12 and the saddle 13 being driven. In addition, the pinion cutter 17 can be moved transversely in the Y axis direction by the slide head 15 being driven. The pinion cutter 17 can be rotated about the cutter axis B by the main shaft 16a of the cutter head 16 being driven to rotate, and the workpiece W can be rotated about the workpiece axis C by the rotary table 18 being driven to rotate.

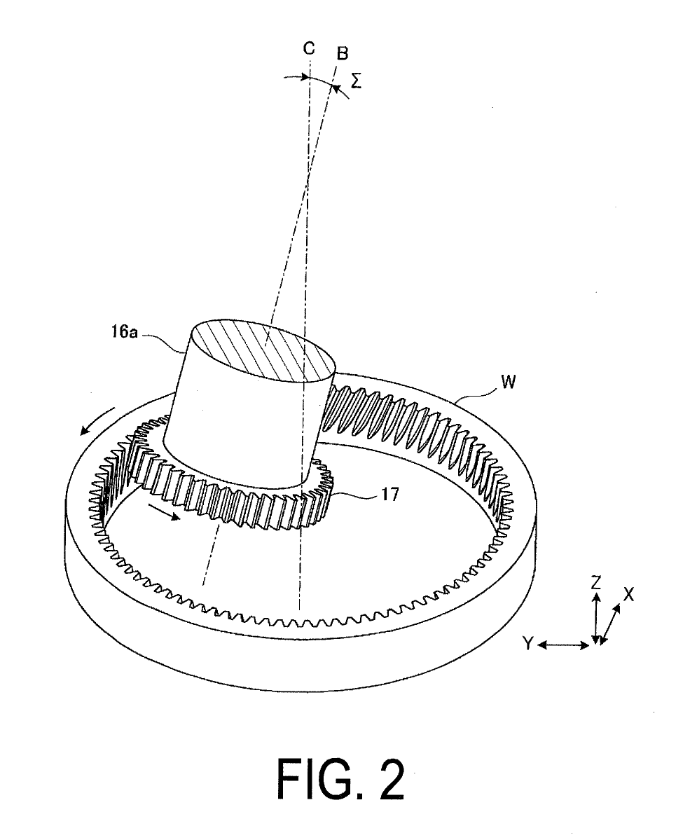

Furthermore, as illustrated in FIG. 1 and FIG. 2, the swivel angle of the cutter axis B corresponding with the axis of the main shaft 16a and the pinion cutter 17 can be changed by the swivel head 14 being swiveled about the cutter swivel axis A. As a result of this configuration, a crossed axis angle Σ of the cutter axis B and the workpiece axis C is adjustable, and the crossed axis angle Σ is adjusted in accordance with the helix angle, and the like of the workpiece W.

Specifically, the crossed axis angle Σ is the crossing angle formed by the cutter axis B and the workpiece axis C within the YZ plane (first plane, vertical plane) including the Y and Z axis. Consequently, upon gear cutting, the pinion cutter 17 rotates about the cutter axis B that crosses with the workpiece axis C of the workpiece W forming the crossed axis angle Σ.

Note that as described above, because the swivel head 14 is able to swivel about the cutter swivel axis A, not only the cutter axis B corresponding to the axis of the main shaft 16a and the pinion cutter 17, but also the movement direction of the slide head 15 supported by the swivel head 14 swivels (inclines) in accordance with the swivel motion of the swivel head 14.

In other words, the pinion cutter 17 is moved in the Y axis direction corresponding to the device transverse direction (width direction of the slide head 17) and the cutter axis B is positioned to always be orthogonal to the X and Y axis directions regardless of what angle the swivel angle of the cutter axis B is. Even in the case of the swivel angle of the cutter axis B being 0°, the Y axis direction becomes orthogonal to the X and Z axis directions and the cutter axis B aligns with the Z axis direction (is parallel to the workpiece axis C).

Here, as described above, the cutter axis B of the pinion cutter 17 swivels within the YZ plane. However, due to errors in the assembly of each component and the like of the internal-gear machining device 1, the cutter axis B may not be able to come parallel to the YZ plane. Specifically, the cutter axis B may be inclined to (cross) the YZ plane. In such a state, gear cutting of the workpiece W with the pinion cutter 17 may result in the quality of the gear becomes worse.

As such, the internal-gear machining device 1 according to the present invention detects, prior to gear cutting, an angle of inclination φ of the cutter axis B with respect to the YZ plane and positions the pinion cutter 17 in a position such that the angle of inclination φ is offset.

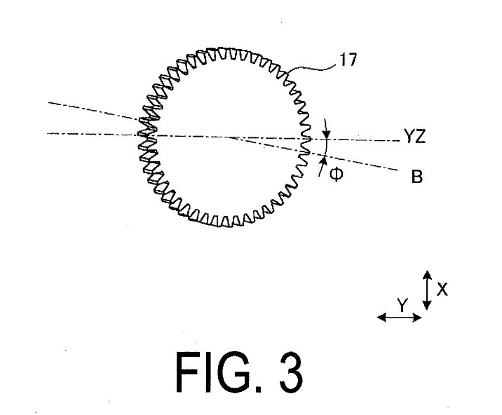

Specifically, as illustrated in FIG. 3, the internal-gear machining device 1 includes a detecting function (detecting unit, detector) that detects the angle of inclination φ of the cutter axis B with respect to the YZ plane. The details are described below. Firstly, the internal-gear machining device 1 sets an offset position Pb (X axis coordinate: Xb, Y axis coordinate: Yb) in the XY plane (second plane, horizontal plane) including the X axis and Y axis in accordance to the detected angle of inclination φ. The coordinates of the offset position Pb have an origin at the central position of the workpiece W (workpiece axis C). Next, the pinion cutter 17 is horizontally moved within the XY plane in a manner such that the cutter axis B passes through the offset position Pb.

In such a manner, the cutter axis B that is inclined at an angle of inclination φ with respect to the YZ plane is horizontally moved in accordance with the angle of inclination φ within the XY plane. As a result, the pinion cutter 17 rotatable about this cutter axis B can be meshed with the workpiece W with the angle of inclination φ offset.

Next, the operation of the internal-gear machining device 1 is explained using FIG. 2 to FIG. 6.

First, the pinion cutter 17 is swiveled about the cutter swivel axis A so that the crossed axis angle Σ is set with the cutter axis B. Next, as illustrated in FIG. 3, the pinion cutter 17 is moved in the X axis, Y axis, and Z axis direction and positioned so as to be within a region in which the angle of inclination φ is detectable. The angle of inclination φ of the cutter axis B with respect to the YZ plane is then detected.

When the detected angle of inclination φ is 0°, the cutter axis B of the pinion cutter 17 is deemed to be parallel to the YZ plane, and gear cutting is performed without any change to the gear cutting initial position of the pinion cutter 17 within the XY plane.

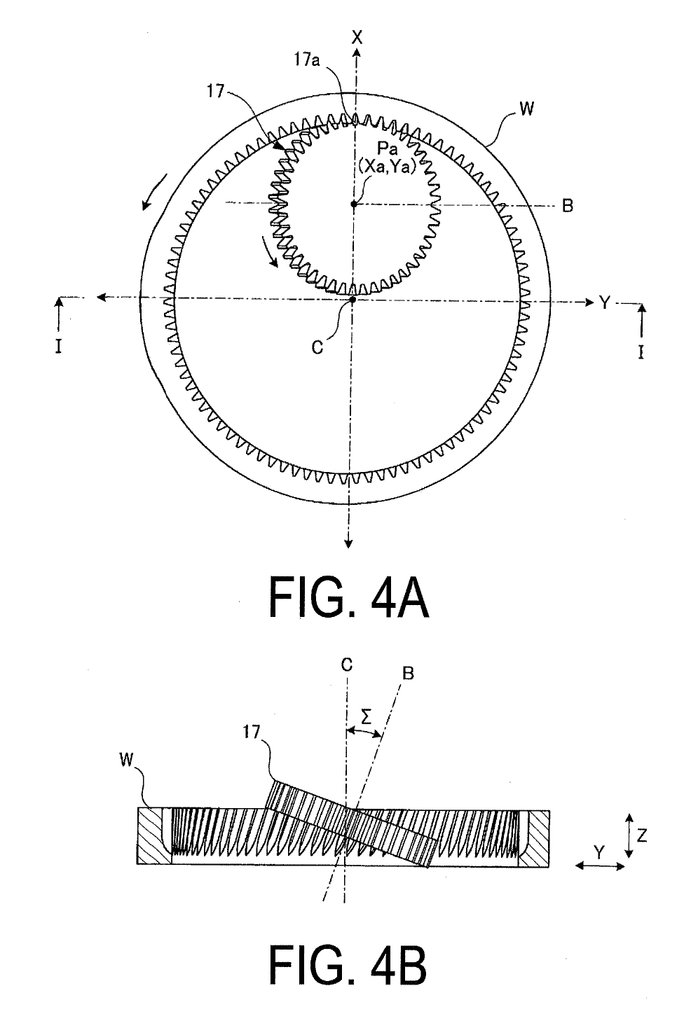

In other words, as illustrated in FIGS. 4A and 4B, the pinion cutter 17 is moved in the X axis, Y axis, and the Z axis direction. Then, the pinion cutter 17 is meshed with the workpiece W in a state with the crossed axis angle Σ set.

At this time, the pinion cutter 17 is positioned so that the cutter axis B passes through a reference position Pa (X axis coordinate: Xa, Y axis coordinate: Ya) within the XY plane. The coordinates of the reference position Pa have an origin at the central position of the workpiece W (workpiece axis C). In addition, a meshing position 17a of the pinion cutter 17 positioned at the reference position Pa and the workpiece W is positioned to be on a straight line (on the X axis) within the XY plane that passes through the central position of the workpiece W (workpiece axis C) and the reference position Pa (cutter axis B).

Next, from the meshed state described above, the pinion cutter 17 is rotated about the cutter axis B and the workpiece W is rotated about the workpiece axis C. Then, the pinion cutter 17 is caused to cut in the X axis direction and is fed in the Z axis direction. Specifically, the meshed pinion cutter 17 and the workpiece W are rotated synchronously, and the pinion cutter 17 progressively cuts in the X axis direction while being moved up and down in the Z axis direction.

Note that the pinion cutter 17 moved up and down in the Z axis direction cuts only when being moved in the downward direction and is separated from the workpiece W in the X axis direction and does not cut when being moved in the upward direction.

As a result of this configuration, the pinion cutter 17 and the workpiece W slide against each other to a large degree, whereby, due to the blade face (tooth face) of the pinion cutter 17, an internal gear is cut into the workpiece W.

However, when the detected angle of inclination φ is greater than 0°, the cutter axis B of the pinion cutter 17 is deemed to be not parallel to the YZ plane, and the gear cutting initial position of the pinion cutter 17 within the XY plane is adjusted prior to gear cutting.

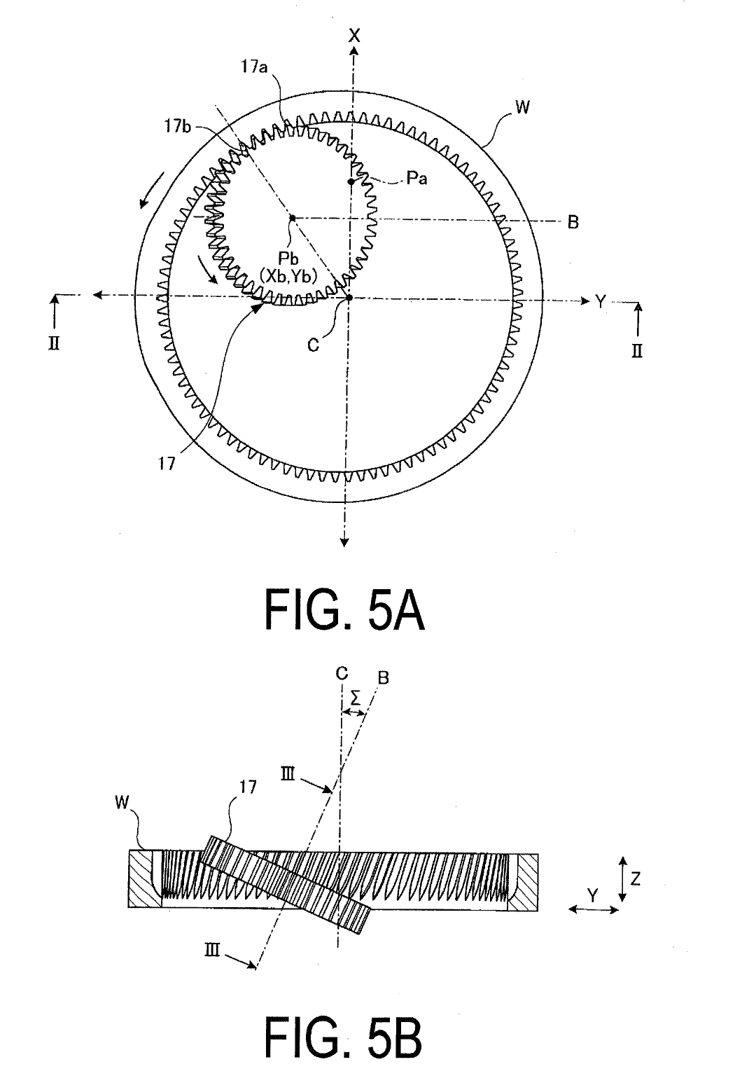

In other words, as illustrated in FIG. 2 and FIGS. 5A and 5B, the pinion cutter 17 is moved in the X axis, Y axis, and the Z axis direction. Then, the pinion cutter 17 is meshed with the workpiece W in a state with the crossed axis angle Σ set.

At this time, the pinion cutter 17 is positioned so that the cutter axis B passes through the offset position Pb within the XY plane. The coordinates of the offset position Pb have an origin at the central position of the workpiece W (workpiece axis C). In addition, a meshing position 17b of the pinion cutter 17 positioned at the offset position Pb and the workpiece W is positioned to be both on a straight line within the XY plane that passes through the central position of the workpiece W (workpiece axis C) and the offset position Pb (cutter axis B) and located shifted from the meshing position 17a with respect to the rotational direction of the pinion cutter 17.

Specifically, the cutter axis B inclined at the angle of inclination φ at the reference position Pa is parallel shifted within the XY plane from the reference position Pa to the offset position Pb, and the meshing position of the pinion cutter 17 and the workpiece W is shifted from the meshing position 17a to the meshing position 17b. As a result, the meshing direction on the XY plane of the pinion cutter 17 and the workpiece W is changed from the reference axis direction that passes through the central position of the workpiece W and the reference position Pa to the offset axis direction that passes through the central position of the workpiece W and the offset position Pb.

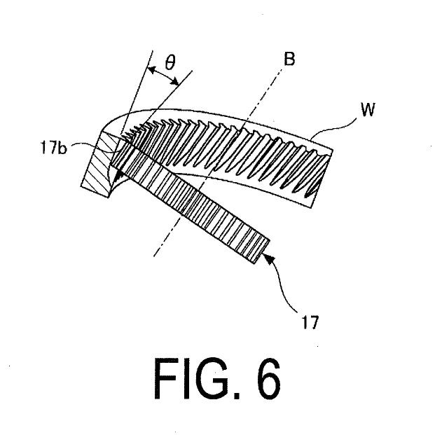

In addition, as illustrated in FIG. 6, by both positioning the cutter axis B at the offset position Pb and shifting the meshing position of the pinion cutter 17 to the meshing position 17b, the lower end side of the pinion cutter 17 meshes with the workpiece W, and the pinion cutter 17 separates from the workpiece W toward the upper end side of the pinion cutter 17 at the meshing position 17b. Specifically, a relief angle θ is set at the meshing position 17b of the pinion cutter 17.

Next, from the meshed state described above, the pinion cutter 17 is rotated about the cutter axis B and the workpiece W is rotated about the workpiece axis C. Then, the pinion cutter 17 is caused to cut in the X axis direction and is fed in the Z axis direction. Specifically, the meshed pinion cutter 17 and the workpiece W are synchronously rotated, and the pinion cutter 17 progressively cuts in the X axis direction while being moved up and down in the Z axis direction.

Note that the pinion cutter 17 moved up and down in the Z axis direction cuts only when being moved in the downward direction and is separated from the workpiece W in the X axis direction and does not cut when being moved in the upward direction.

As a result of this configuration, the pinion cutter 17 and the workpiece W slide against each other to a large degree, whereby, due to the blade face (tooth face) of the pinion cutter 17, an internal gear is cut into the workpiece W.

In such a manner, prior to gear cutting, the pinion cutter 17 is positioned so that the cutter axis B is parallel shifted within the XY plane in accordance with the angle of inclination o of the cutter axis B, and the meshing position of the pinion cutter 17 and the workpiece W is shifted in the cutter rotational direction. As a result, even should the angle of inclination φ be set at the cutter axis B due to errors in the assembly of the device and the like, the angle of inclination φ can be offset using a conventional configuration, and high-precision machining can be performed.

In addition, by both positioning the cutter axis B at the offset position Pb and shifting the meshing position of the pinion cutter 17 to the meshing position 17b, the pinion cutter 17 can have the relief angle θ at the meshing position 17b. As a result, the relief angle θ can be easily set even when using a cylindrical pinion cutter 17, allowing for the use of non-tapered pinion cutters.

### INDUSTRIAL APPLICABILITY

The present invention can be applied to an internal-gear machining device that machines an internal gear to be machined using a shaping cutter or a barrel-shaped threaded grinding wheel.

1. An internal-gear machining device that cuts an internal gear to be machined rotatable about a workpiece axis with a gear-shaped cutter rotatable about a cutter axis by feeding and causing the gear-shaped cutter to cut while synchronously rotating the internal gear to be machined and the gear-shaped cutter in mesh with each other, the internal-gear machining device comprising:
a cutting unit that infeeds the gear-shaped cutter in an infeeding direction orthogonal to the workpiece axis;
a cutter transverse feeding unit that moves the gear-shaped cutter in a transverse direction orthogonal to the infeeding direction and the cutter axis;
a cutter feeding unit that moves the gear-shaped cutter in a feeding direction parallel to the workpiece axis;
a swivel unit that swivels the cutter axis about a cutter swivel axis extending in the infeeding direction and sets a crossed axis angle between the cutter axis and the workpiece axis; and
a detecting unit that detects an angle of inclination with respect to a first plane of the cutter axis having the crossed axis angle, the first plane including the transverse axis and the feeding axis;
prior to gear cutting, the gear-shaped cutter being positioned so that the cutter axis is parallel shifted by the cutting unit and the cutter transverse feeding unit within a second plane in accordance with the angle of inclination detected by the detecting unit, the second plane including the cutting axis and the transverse axis, and
a meshing position of the gear-shaped cutter and the internal gear to be machined being shifted in a rotational direction of the gear-shaped cutter.

2. The internal-gear machining device according to claim 1, wherein
the gear-shaped cutter is cylindrical; and
a relief angle is set at the meshing position of the gear-shaped cutter having the parallel shifted cutter axis.

3. A method of machining an internal gear, comprising the step of:
cutting an internal gear to be machined rotatable about a workpiece axis with a gear-shaped cutter rotatable about a cutter axis by feeding the gear-shaped cutter in a feeding direction parallel to the workpiece axis and causing the gear-shaped cutter to cut in an infeeding direction orthogonal to the workpiece axis while synchronously rotating the internal gear to be machined and the gear-shaped cutter in mesh with each other; and comprising the steps performed prior to the gear cutting of:
setting a crossed axis angle between the cutter axis and the workpiece axis by swiveling the cutter axis;
detecting an angle of inclination with respect to a first plane of the cutter axis having the crossed axis angle, the first plane including a transverse axis orthogonal to the infeeding direction and the cutter axis and the feeding axis; and
shifting a meshing position of the gear-shaped cutter and the internal gear to be machined in a rotational direction of the gear-shaped cutter by positioning the gear-shaped cutter so that the cutter axis is parallel shifted within a second plane in accordance with the angle of inclination, the second plane including the cutting axis and the transverse axis.
